(19) United States
(12) Patent Application Publication
(10) Pub. No.: US 2001/0054144 A1
(43) Pub. Date: Dec. 20, 2001

(54) Confirming the existence of a complete data set under multiple control scenarios

(76) Inventors: Michael Epstein, Spring Valley, NY (US); Martin Rosner, Hastings-on -Hudson, NY (US)

Correspondence Address: Corporate Patent Counsel, U.S. Philips Corporation, 580 White Plains Road, Tarrytown, NY, 10591, US

(21) Appl. No.: 09/848,885

(22) Filed: May 4, 2001

Related U.S. Application Data
(60) Provisional application No. 60/211,997, filed on Jun. 16, 2000.

(51) Int. Cl. H04L 9/00; H04K 1/00; H04L 9/32

(52) U.S. Cl. 713/161; 713/200; 713/193; 713/176; 380/28

(57) ABSTRACT

A verification system is configured to verify the presence of an entire data set before individual data items within the set can be accessed for playback or other processing. Each data item in the data set comprises one or more sections, and the totality of sections constitute the complete data set. Each section of the data set contains a watermark that includes an identifier that confirms the presence of the section as originally recorded. The presence of the data set is confirmed by checking the watermarks of randomly selected sections to verify that the original sections that formed the data set are present, or, by maintaining a record of accessed sections to verify that a substantial portion of the data set is present. To allow for the possible noise-corruption of one or more watermarks, the verification system is configured to allow for a less-than-absolute verification. To allow for an inability to acquire the randomly selected sections on-demand, the verification system is also configured to confirm the presence of the data set based on a receipt of a substantial portion of the data set. The verification system is configured to interact with a recording or other rendering system, such that the content material is stored in a secure format that prevents further access until the verification system provides a key to allow access. In a preferred embodiment, the identifiers are stored as a combination of robust and fragile watermarks.

This application claims the benefit of U.S. Provisional Application No. 60/211,997 filed Jun. 16, 2000, Attorney Docket US000140P.

### BACKGROUND OF THE INVENTION

1. Field of the Invention

This invention relates primarily to the field of consumer electronics, and in particular to the protection of copy-protected content material.

2. Description of Related Art

The illicit distribution of copyright material deprives the holder of the copyright legitimate royalties for this material, and could provide the supplier of this illicitly distributed material with gains that encourage continued illicit distributions. In light of the ease of information transfer provided by the Internet, content material that is intended to be copy-protected, such as artistic renderings or other material having limited distribution rights, are susceptible to wide-scale illicit distribution. The MP3 format for storing and transmitting compressed audio files has made the wide-scale distribution of audio recordings feasible, because a 30 or 40 megabyte digital audio recording of a song can be compressed into a 3 or 4 megabyte MP3 file. Using a typical 56 kbps dial-up connection to the Internet, this MP3 file can be downloaded to a user's computer in a few minutes. Thus, a malicious party could read songs from an original and legitimate CD, encode the songs into MP3 format, and place the MP3 encoded song on the Internet for wide-scale illegitimate distribution. Alternatively, the malicious party could provide a direct dial-in service for downloading the MP3 encoded song. The illicit copy of the MP3 encoded song can be subsequently rendered by software or hardware devices, or can be decompressed and stored onto a recordable CD for playback on a conventional CD player.

A number of schemes have been proposed for limiting the reproduction of copy-protected content material. The Secure Digital Music Initiative (SDMI) and others advocate the use of “digital watermarks” to identify authorized content material. EP 0981901 “Embedding auxiliary data in a signal” issued Mar. 1, 2000 to Antonius A. C. M. Kalker, discloses a technique for watermarking electronic material, and is incorporated by reference herein. As in its paper watermark counterpart, a digital watermark is embedded in the content material so as to be detectable, but unobtrusive. An audio playback of a digital music recording containing a watermark, for example, will be substantially indistinguishable from a playback of the same recording without the watermark. A watermark detection device, however, is able to distinguish these two recordings based on the presence or absence of the watermark. Because some content material may not be copy-protected and hence may not contain a watermark, the absence of a watermark cannot be used to distinguish legitimate from illegitimate material. On the contrary, the absence of a watermark is indicative of content material that can be legitimately copied freely.

Other copy protection schemes are also available. For example, European patent EP0906700, “Method and system for transferring content information and supplemental information related thereto”, issued Apr. 7, 1999 to Johan P. M. G. Linnartz et al, presents a technique for the protection of copyright material via the use of a watermark “ticket” that controls the number of times the protected material may be rendered, and is incorporated by reference herein.

An accurate reproduction of watermarked material will cause the watermark to be reproduced in the copy of the watermarked material. An inaccurate, or lossy reproduction of watermarked material, however, may not provide a reproduction of the watermark in the lossy copy of the material. A number of protection schemes, including those of the SDMI, have taken advantage of this characteristic of lossy reproduction to distinguish legitimate material from illegitimate material, based on the presence or absence of an appropriate watermark. In the SDMI scenario, two types of watermarks are defined: “robust” watermarks, and “fragile” watermarks. A robust watermark is one that is expected to survive a lossy reproduction that is designed to retain a substantial portion of the original content material, such as an MP3 encoding of an audio recording. That is, if the reproduction retains sufficient information to allow a reasonable rendering of the original recording, the robust watermark will also be retained. A fragile watermark, on the other hand, is one that is expected to be corrupted by a lossy reproduction or other illicit tampering.

In the SDMI scheme, the presence of a robust watermark indicates that the content material is copy protected, and the absence or corruption of a corresponding fragile watermark when a robust watermark is present indicates that the copy protected material has been tampered with in some manner. An SDMI compliant device is configured to refuse to render watermarked material with a corrupted watermark, or with a detected robust watermark but an absent fragile watermark, except if the corruption or absence of the watermark is justified by an “SDMI-certified” process, such as an SDMI compression of copy protected material for use on a portable player. For ease of reference and understanding, the term “render” is used herein to include any processing or transferring of the content material, such as playing, recording, converting, validating, storing, loading, and the like. This scheme serves to limit the distribution of content material via MP3 or other compression techniques, but does not affect the distribution of counterfeit unaltered (uncompressed) reproductions of content material. This limited protection is deemed commercially viable, because the cost and inconvenience of downloading an extremely large file to obtain a song will tend to discourage the theft of uncompressed content material.

### BRIEF SUMMARY OF THE INVENTION

It is an object of this invention to extend the protection of copy-protected material to include the protection of uncompressed content material. It is a further object of this invention to provide this protection independent of the degree of control of the access device that provides the material.

This object and others are achieved by providing a verification system that is configured to verify the presence of an entire data set before individual data items within the set can be accessed for playback or other processing. Each data item in the data set comprises one or more sections, and the totality of sections constitute the complete data set. Each section of the data set contains a watermark or other identifier that confirms the presence of the section as originally recorded. The presence of the data set is confirmed by checking the watermarks of randomly selected sections to verify that the original sections that formed the data set are present, or, by maintaining a record of accessed sections to verify that a substantial portion of the data set is present. To allow for the possible noise-corruption of one or more watermarks, the verification system is configured to allow for a less-than-absolute verification. To allow for an inability to acquire the randomly selected sections on-demand, the verification system is also configured to confirm the presence of the data set based on a receipt of a substantial portion of the data set. The verification system is configured to interact with a recording or other rendering system, such that the content material is stored in a secure format that prevents further access until the verification system provides a key to allow access. In a preferred embodiment, the identifiers are stored as a combination of robust and fragile watermarks.

### BRIEF DESCRIPTION OF THE DRAWINGS

The invention is explained in further detail, and by way of example, with reference to the accompanying drawings wherein:

FIG. 1 illustrates an example system for protecting copy-protected content material in accordance with this invention.

FIG. 2 illustrates an example data structure that facilitates a determination of the presence of an entirety of a data set in accordance with this invention.

FIG. 3 illustrates an example flow diagram of a verification system for controlling access to content material in dependence upon the presence of an entirety of a data set in accordance with this invention.

Throughout the drawings, the same reference numerals indicate similar or corresponding features or functions.

### DETAILED DESCRIPTION OF THE INVENTION

For ease of understanding, the invention is presented herein in the context of digitally recorded songs. As will be evident to one of ordinary skill in the art, the invention is applicable to any recorded information that is expected to be transmitted via a limited bandwidth communications path. For example, the individual content material items may be data records in a larger database, rather than songs of an album.

The theft of an item can be discouraged by making the theft more time consuming or inconvenient than the worth of the stolen item. For example, a bolted-down safe is often used to protect small valuables, because the effort required to steal the safe will typically exceed the gain that can be expected by stealing the safe. Copending U.S. patent application “Protecting Content from Illicit Reproduction by Proof of Existence of a Complete Data Set”, U.S. Ser. No. 09/537,815, filed Mar. 28, 2000 for Michael A. Epstein, Attorney Docket US000035, teaches selecting and binding data items to a data set that is sized sufficiently large so as to discourage a transmission of the data set via a bandwidth limited communications system, such as the Internet, and is incorporated by reference herein. This copending application teaches a binding of the data items in the data set by creating a watermark that contains a data-set-entirety parameter and embedding this watermark into each section of each data item. The copending application also teaches including a section-specific parameter (a random number assigned to each section) in the watermark. The referenced copending application teaches the use of “out of band data” to contain the entirety parameter, or information that can be used to determine the entirety parameter. The section watermarks are compared to this entirety parameter to assure that they are the same sections that were used to create the data set and this entirety parameter. To minimize the likelihood of forgery, the entirety parameter is based on a hash of a composite of section-specific identifiers. The referenced copending application also teaches the use of digitally signed certificates and other techniques that rely on cryptographic techniques, such as hashing and the like.

Copending U.S. patent application “Protecting Content from Illicit Reproduction by Proof of Existence of a Complete Data Set via a Linked List”, U.S. Ser. No. 09/537,079, filed Mar. 28, 2000 for Antonius A. M. Staring and Michael A. Epstein, Attorney Docket US000088, teaches a self-referential data set that facilitates the determination of whether the entirety of the data set is present, without the use of out of band data and without the use of cryptographic functions, such as a hash function. This copending application creates a linked list of sections of a data set, encodes the link address as a watermark of each section, and verifies the presence of the entirety of the data set by verifying the presence of the linked-to sections of some or all of the sections of the data set.

Copending U.S. patent application “Protecting Content from Illicit Reproduction by Proof of Existence of a Complete Data Set via Self-Referencing Sections”, U.S. Ser. No. 09/536,944, filed Mar. 28, 2000 for Antonius A. M. Staring, Michael A. Epstein, and Martin Rosner, Attorney Docket US000040, teaches a self-referential data set wherein each section of a data set is uniquely identified and this section identifier is associated with each section in a secure manner. To assure that a collection of sections are all from the same data set, an identifier of the data set is also securely encoded with each section. Preferably, the section identifier and the data set identifier are encoded as a watermark that is embedded in each section, preferably as a combination of robust and fragile watermarks. Using exhaustive or random sampling, the presence of the entirety of the data set is determined, either absolutely or with statistical certainty.

In each of these copending applications, if the entirety of the data set is not present, subsequent processing of the data items of the data set is terminated. In the context of digital audio recordings, a compliant playback or recording device is configured to refuse to render an individual song in the absence of the entire contents of the CD. The time required to download an entire album on a CD in uncompressed digital form, even at DSL and cable modem speeds, can be expected to be greater than an hour, depending upon network loading and other factors. Thus, by requiring that the entire contents of the CD be present, at a download “cost” of over an hour, the likelihood of a theft of a song via a wide-scale distribution on the Internet is substantially reduced.

The aforementioned copending applications each assume that the verification device is integral to the device that accesses the data items, such that the access device responds to particular requests from the verification device. That is, for example, in the linked-list encoding scheme of the aforementioned copending application 09/537,079, the verification device sequentially requests the section identified in each prior section. The access device, in response, accesses the requested section and provides the verification information, such as the watermark, or a decoding of the watermark, corresponding to the requested section, or the entirety of the requested section, to the verification system. If the proper verification is received, the next link-addressed section is requested, and so on. Similarly, in the random selection scheme, the verification system requests a randomly selected section, and the access system is expected to provide the verification information corresponding to this random selection. In each of these copending applications, the verification process is not only dependent upon whether the entirety of the data set is present, but also dependent upon an accurate response from the access system to each request from the verification system.

This invention provides a verification system and method that allows for the verification of an entirety of the data set without reliance upon an access system that is necessarily responsive to requests from the verification system. If the access system is responsive to the verification system's requests, the verification process occurs more quickly and efficiently, but the verification does not fail merely because of an improper or inaccurate response. If the access system is unresponsive to the verification system, due, for example to the lack of a control channel between the verification system and the access system, but evidence is provided that demonstrates that the entirety of the data set is present, the verification system of this invention will permit the subsequent access to, or processing of, the received data items. By distinguishing between the receipt of a proper response and the presence of the entirety of the data set, the verification system of this invention can be configured to be less affected by the effectiveness of the request-response communication channel between the verification system and the access system, and thereby be more sensitive to a demonstrated presence of the entirety of the data set.

FIG. 1 illustrates an example block diagram of a protection system 100 that protects against the unauthorized rendering of material from an incomplete data set. The protection system 100 comprises an encoder 110 that encodes content material onto a medium 130, and a decoder 120 that renders the content material from the medium 130. The encoder 110 includes a selector 112 that selects content material from a source, a binder 116 that builds an entirety verification structure, and a recorder 114 that records the content material with the entirety verification structure onto the medium 130. The selector 112, for example, may be configured to select content information corresponding to songs that are being compiled into an album. Each selected content material item is termed a data item; each data item includes one or more sections of data comprising the data item. The binder 116 is configured to bind each section to the data set, to facilitate a determination of whether the entirety of the data set is present when a data item of the data set is presented for rendering, for example, when a selected song is presented to a rendering device for playback. The recorder 114 appropriately formats, encodes, and stores the information on the medium 130, using techniques common in the art.

The selector 112 selects data items to be added to the data set until the size of the data set is deemed large enough to discourage a subsequent transmission of the data set via a limited bandwidth communications channel. This “discouraging size” is a subjective value, and will depend upon the assumed available communications bandwidth, the loss incurred by the transmission, and so on. Other criteria may also be used to determine whether to add additional data items to the data set. For example, if the data items correspond to songs of an existing album collection, all of the songs will typically be added to the data set, regardless of whether the size of the data set has exceeded the determined discouraging size. If all of the songs of the album collection have been selected, and the discouraging size criterion has not yet been reached, other data items are selected to accumulate the required discouraging size. For example, data items comprising random data bits may be added to the data set to increase its size. These random bits will typically be stored as out of band data, CD-ROM data, and the like, to prevent it from being rendered as audible sounds by a conventional CD player. Alternatively, the data items may comprise other sample songs that are provided to encourage the sale of other albums, or images and video sections related to the recorded content material. Similarly, promotional material, such as Internet access subscription programs may also be included in the recorded information on the recorded medium. These and other means of adding size to a data set will be evident to one of ordinary skill in the art in view of this invention.

The encoder 110 includes a binder 116 that creates an identifier for each section that facilitates a verification of the existence of the entirety of the data set. Any of a variety of techniques may be used to create these identifiers, including those of the aforementioned copending applications. Preferably, the identifiers are encoded using a combination of fragile and robust watermarks, the robust watermark providing a non-removable indication that the material is copy protected, and the fragile watermark providing a means for detecting an unauthorized modification of the material. For ease of reference, an encoding scheme such as presented in the aforementioned copending application 09/536,944 is used herein to illustrate the principles of this invention, although it will be evident to one of ordinary skill in the art that the invention is not limited to this particular encoding or binding scheme.

In accordance with the referenced 09/536,944 disclosure, the identifier of each section is the address that is used for accessing the particular section, and the data set identifier is a somewhat-unique identifier that reduces the likelihood of different data sets having the same identifier, thereby reducing the likelihood of an illicit substitution of sections from different data sets. In a preferred embodiment, for example, the data set identifier includes a 64 bit random number, and a parameter that can be used to determine the total size of the data set. The binder 116 communicates the data set identifier and the unique identifier of each section to the recorder 114 for recording onto the medium 130.

The decoder 120 in accordance with this invention comprises a renderer 122 and a gate 124 that is controlled by an entirety verifier 126. The renderer 122 is configured to receive information from a medium access device 132, which may be an independent device, a component of a multimedia system, a solid-state or disk memory device, and so on. For convenience, a CD reader is used as the example access device 132.

The dotted lines of FIG. 1 illustrate an example song extractor 142 that extracts a song from the medium 130 and communicates it to an example CD imitator 144, representative of a possible illicit download of the song via the Internet. The CD imitator 144 represents, for example, a software program that provides information in a conventional CD output format. Alternatively, the song extractor 142 may be a device that records songs from a variety of sources to produce an illicit CD containing an unauthorized compilation of songs. In this case the illicit CD is provided to the conventional access device 132.

Depending upon the particular capabilities of the access device 132, and the control channel between the decoder 120 and the access device 132, the access device 132 may operate independent of, or in response to commands from, the decoder 120. An independent access device 132 typically provides the information from the media in response to a “play” command, via, for example, a user's activation of a control on the device 132. A controlled access device 132, on the other hand, provides specific material, based on a specific request from the renderer 122. The renderer 122 retrieves the material by specifying a location index, and in response, the access device 132 provides the data located at the specified location index on the medium 130. In a typical memory structure comprising tracks and sections, a section of data is retrieved by specifying a track and section address, or a track and time offset.

The entirety verifier 126 is configured to obtain data from the medium 130, typically via the renderer 122, to determine whether the entire data set is present. In a preferred system based on watermarks, the renderer 122 is configured to determine the watermark associated with each section of data that is read from the medium 130. The entirety verifier 126 uses the watermarks to determine whether the entirety of the data set is available to the renderer 122, as discussed below. In accordance with this invention, this entirety verification is provided regardless of whether the access device 132 is responsive to specific requests of the renderer 122, or whether the access device 132 provides material independently. If the access device 132 is responsive to the renderer 122, the verification can generally be more efficiently performed, using, for example, statistical tests. Note that the responsiveness aspect of the access device includes both an automated response, or a response based on a user intervention. That is, for example, for systems that lack a control channel from the renderer 122 to the access device 132, the renderer 122 may display a request for particular material, such as a request for a particular song on the medium 130, and the user may manually control the device 132 to provide the requested material. In this manner, the user can facilitate the rapid verification of the presence of the entirety of the data set.

Depending upon the particular function of the decoder 120, the entirety verifier 126 and gate 124 effect different control over the rendered content material. If the decoder 120 is a recorder, for example, the renderer 122 may be configured to store the received content material in a secure, “locked”, form that precludes subsequent rendering of the material until the entirety verifier 126 provides a key to the gate 124. In this manner, the recording of the material can be effected while the verification process is taking place, the only delay caused by this invention being the time required to unlock the material for subsequent rendering. Any of a variety of encoding techniques can be employed to effect an efficient locking and unlocking scheme. If the decoder 120 is a playback device, the rendered content may be provided while the verification process occurs during the first access to the material, then precluded for subsequent rendering if the verification fails. That is, in a preferred embodiment, the verifier 126 maintains a memory of verified and non-verified data items. If a verified item is subsequently presented, the verification process can be bypassed. If a non-verified data item is subsequently presented, the verifier 126 will prevent the subsequent rendering until it verifies the presence of the entirety of the data set. These and other methods of interfering with the rendering of suspect material, while still providing an efficient process for rendering untested, or as-yet-unknown, material, will be evident to one of ordinary skill in the art.

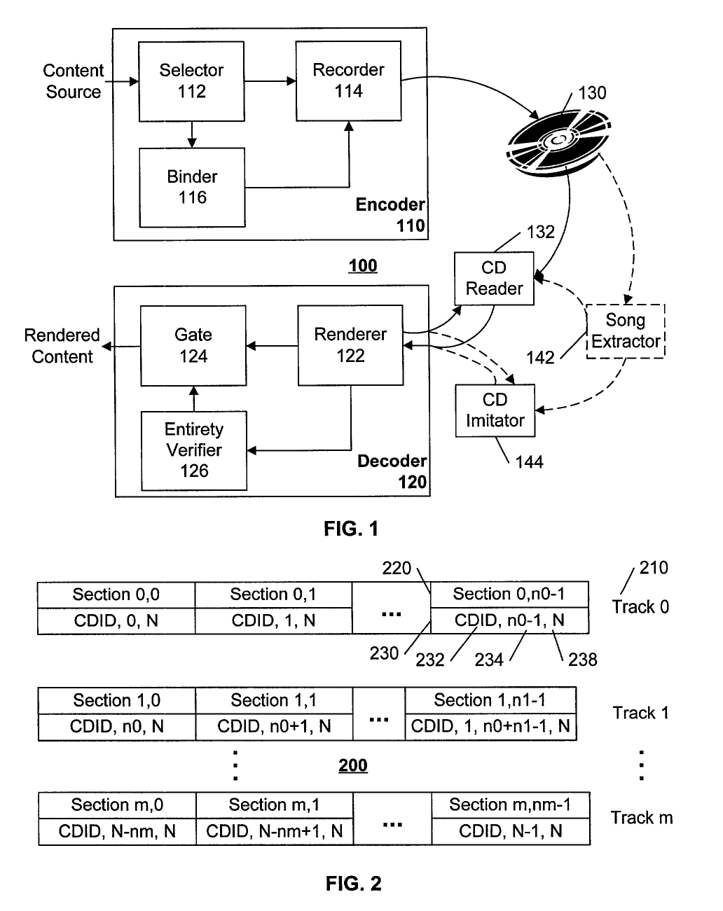

FIG. 2 illustrates an example data structure 200 for storing data items in a data set that facilitates a determination of whether the entirety of the original data set is present. A track 210 and section 220 is illustrated, consistent with the memory structure of conventional CD and other storage media. As illustrated, each track 210 may have a different number of sections 220 (n0, n1, etc.). In the example data structure 200, each section contains ancillary information 230 that is used by a compliant rendering device to verify that the entirety of the data set is present. As discussed above, in accordance with this invention, the ancillary information 230 of each section 220 contains a unique identifier of the section and a unique identifier of the data set. The unique identifier of the data set is illustrated as the CDID 232 parameter that is encoded with each section, as discussed above. The unique identifier of each section is illustrated as an incremental index 234. The total number of sections in the data set, N 238, is also included, to facilitate the determination that at least a substantial portion of these N sections are present when a select data item is presented to the decoder 120. Preferably, the ancillary information 230 containing these identifiers is encoded as a combination of robust and fragile watermarks that are embedded with each section 220.

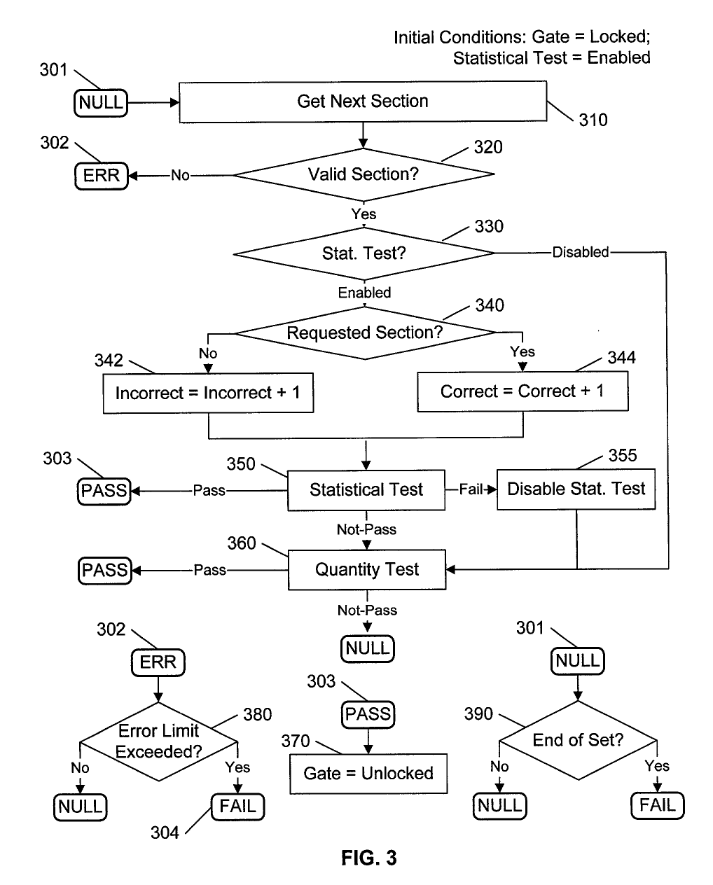

FIG. 3 illustrates an example flow diagram of the verification process in accordance with this invention. It is assumed that the verifier has been enabled, based for example, on the presence of a watermark in the accessed material, and that the verifier defaults to a “gate-locked” state, with the statistical test capability (discussed below) enabled. The verification process commences or continues at block 310, wherein a next section is received for verification. The term “null” state 301 is used herein to represent the continuing state of verification, wherein no actions are taken until a “pass” 303 or “fail” 304 state is achieved. If the statistical test is enabled, the verifier communicates a specific access request for a particular section of the accessed material. Preferably, this request constitutes a random sampling of the accessed material.

At 320, the received section is checked for validity. This check includes, for example, checking that the identifier of the data set (e.g. CDID 232 and/or N 238 in FIG. 2) remains unchanged for each received section, that a valid section identifier (e.g. identifier 234 in FIG. 2) exists, and so on. If the section is not deemed valid, an error state 302 is entered. In accordance with this invention, to allow for noise factors, errors in a watermark encoding or decoding, and so on, a single error does not necessarily result in a fail state 304. At 380, a fail state 304 occurs only when the number of errors thus far, or the severity of a particular error, exceeds an error limit. In a straightforward embodiment, a count of the number of errors is maintained and compared to a predetermined limit, dependent upon the expected reliability of the means used to identify and detect a valid section; in a more complex embodiment, other error limit criteria may be set. If the error limit is not exceeded, at 380, the system returns to the null state 301, and awaits the next section, at 310, or the termination of access to the data set, at 390 (discussed further below).

If the section is verified as being valid, at 320, and the statistical test 330 is enabled, the section identifier is compared to the requested section identifier, at 340. If the section identifier corresponds to the requested section, at 340, a count of correct sections is incremented, at 344; otherwise, a count of incorrect sections is incremented. To accommodate a possible lag time between a request and a corresponding response, the comparison 340 may be offset in time, or asynchronous with the receipt of each particular section. For example, the comparison 340 may be configured to update the correct and incorrect counts should a subsequent section, within a reasonable time period, correspond to a requested section. The statistical test 350 may be any of a variety of formal or informal tests based on the count of correct and/or incorrect responses to the section requests. Formal tests include, for example, a Sequential Probability Ratio Test (SPRT), which compares the ratio of correct and incorrect counts to a likelihood that such a ratio might occur due to factors other than the criteria being tested. For example, if the entirety of the data set were actually present, and the verification system were ideal, one would expect no incorrect counts. In reality, environmental noise and other factors may introduce incorrect counts. In the SPRT, the testing continues until the ratio of counts is so extreme, on one side (pass) or the other (fail), to substantially minimize the possibility that the observed response is due to noise or other random factors. In like manner, a conventional Binomial test may also be used to decide whether the proportion of correct or incorrect responses is statistically significant. Informal tests include, for example, a heuristic “m out-of n” test, such as a “three out of four” test, wherein if three correct responses out of four requests are detected, the presence of the data set is deemed verified, and the testing is terminated. Alternatively, the “m out-of n” test may use the count of incorrect responses to declare a failure of the test. Other tests, such as a detection of a sequential pattern, and the like, may also be used to determine that the access device is non responsive. The statistical test 350 is configured to issue a request for another, preferably random section, unless a success or failed state results.

Although the term “statistical test” is used herein, the test is not limited to “formal” statistical tests having specific characteristics and determinable likelihoods of error. The term statistic is used herein in its general form, meaning a collection of numerical data. The statistical test 350 includes ad hoc and heuristic tests that are formulated to facilitate a decision based on the number or pattern of successes or failures, or other results, that occur. In the context of this invention, the statistical test 350 is a test that is intended to potentially provide a decision based on fewer samples than the quantity test 360, discussed below, thereby improving the efficiency of the verification process for the situations that allow for a more rapid verification of the validity of the content material.

If the statistical test 350 results in a success, the process enters the pass state 303, and, at 370, the gate is “unlocked”, corresponding to the aforementioned gate 124 of FIG. 1, thereby allowing an unencumbered rendering of the current data item, as well as subsequent data items from this same data set. As noted above, if the decoder 120 of FIG. 1 is a recorder, the setting of the gate to an unlocked state results in the conversion of prior data items that were stored in a secure format into a format suitable for subsequent rendering.

In accordance with this invention, it is recognized that the failure of the statistical test may be due to the lack of an entirety of the data set, or, due to the lack of an ability to respond to the verifier's specific requests, or due to a time lag in the response that is not accommodated by the comparison 340, or due to a combination of these or other factors. Therefore, if the test 350 results in a non-pass state (i.e. insufficient information to decide one way or the other), or a failed state (i.e. sufficient information to declare that the responses do not correspond to the requests), the verification is not yet declared to have failed. If the statistical test 350 results in a failed state, the statistical test is disabled, at 355; thereafter, the aforementioned checking of whether the received section corresponds to the requested section, at 340, and the test, at 350, are bypassed.

If the statistical test 350 does not result in a pass state 303, or the test 350 is bypassed, a quantity test 360 is performed. As discussed above, the entirety verifier 126 of FIG. 1 is configured to ascertain that the data item is a part of the original data set; the intent of this verification is to discourage the extraction and subsequent distribution of individual data items from a data set. The quantity test 360 is provided to determine that a sufficient amount of the original data set is present to justify a conclusion that the entire data set is present. Depending upon the level of assurance desired, the quantity test 360 could be configured as an exhaustive test, wherein all of the sections of the data set must be accessed before the test 360 declares a success. Consistent with the aforementioned error limit test 380, discussed above, the quantity test 360 can be configured to be fault tolerant; consistent with the statistical test 350, the quantity test 360 can be configured to use formal or informal test criteria, such as a “m out-of N” test, where m is the number of different sections accessed, and N is the total number of sections comprising the data set. If a sufficient number of different sections are accessed to warrant a determination that the entire data set is highly likely to be present, the quantity test 360 is configured to provide a “pass” output, and the process enters the pass state 303 and unlocks the gate, at 370, discussed above. Otherwise, the process continues in the null state 301, and waits to receive the next section, at 310.

The quantity test 360 need not be a continuous test. In some circumstances, the verification process is time or resource consuming, and a verification of each section may be impractical, or inefficient. A verification of every other section, every fifth section, every tenth section, etc. may be employed to determine whether a quantity of the data set is present. In a preferred embodiment, a random selection of sections, or a random selection of increments between sections, is used to identify the sections that will be verified in the quantity test 360, so that an illicit user cannot predict which particular sections will be subjected to the verification process.

While in the null state 301, the verification process is configured to continuously or periodically check to determine whether the access process has been terminated, at 390, as indicated by the repeated entry into the null state 301 after the termination check at 390. If the access is terminated, before a pass state 303 is determined, a fail state 304 is asserted, and the verification process is terminated. Note that, because the gate is initialized to the locked state, and only unlocked when a pass state 303 is asserted, the termination of the verification process in the fail state 304 results in a continuation of the locked gate state. As discussed above, if the decoder 120 of FIG. 1 is a recorder, this locked gate state prevents the subsequent rendering of the data items that are stored in the aforementioned secure state that precludes rendering. If the decoder 120 is a playback device, the locked gate state is associated with the identifier of the data set, to preclude subsequent renderings of the data set that has been determined to be incomplete. The periodic or continuous check at 390 continues while in the null state 301, until the next section is received, at 310, and the above described process is repeated for this new section.

Note that the validation techniques presented in this invention are not exclusive of other validation and verification techniques. For example, to prevent a “pass and switch” scenario, wherein sufficient valid content material is provided so that the verification system “passes” the material, and invalid content material is provided thereafter, the validation system may be configured to apply additional tests after the initial “pass” determination. For example, in a preferred embodiment, the decoder 120 of FIG. 1 is configured to periodically or randomly test the content material for a consistent set-identifier, such as the CDID of FIG. 2. This testing occurs throughout the rendering of the content material. If the set-identifier changes, indicating that the material being rendered is not from the set that was verified, the decoder 120 terminates the rendering and/or resets the gate condition to “locked” and re-enters the validation process of FIG. 3. Other tests that verify a correspondence between the material being rendered and the material approved for rendering will be evident to one of ordinary skill in the art in view of this disclosure.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

We claim:

1. A system that is configured to receive one or more select data items of a plurality of data items corresponding to a data set, comprising:
a verifier that is configured to provide a verification of a presence of the data set, via:
a first verification of a presence of a select subset of the plurality of data items, and
a second verification of a receipt of a substantial majority of the plurality of data items, and
wherein the verifier provides the verification of the presence of the data set if either the first verification or the second verification occurs.

2. The system of claim 1, further including
a renderer that is configured to receive the data items, and
a gate, operably coupled to the renderer and the verifier, that is configured to selectively inhibit or allow access to an output of the renderer corresponding to the data item, based on the verification of the presence of the data set.

3. The system of claim 2, wherein
the renderer is further configured to store the one or more select data items in a secure format that inhibits a subsequent rendering of the data items, and
the gate is further configured to allow the subsequent rendering of the data items from the secure format.

4. The system of claim 2, wherein
the system is further configured to provide a recording of the one or more data items.

5. The system of claim 1, wherein
the verifier is configured to identify the select subset, based on a random process, and
the first verification includes consideration of a likelihood of receiving the select subset of data items by chance occurrence.

6. The system of claim 1, wherein
the verifier is configured to identify the select subset, based on a random process, and
the first verification includes consideration of a likelihood of not receiving a data item of the select subset even though the data item is present.

7. The system of claim 1, wherein
at least one of the first verification and the second verification includes a likelihood of an inaccurate reception of the one or more data items.

8. The system of claim 1, wherein
each data item of the plurality data items includes one or more sections, thereby forming a plurality of sections comprising the data set,
each section of the plurality of sections including a section identifier corresponding to the section and a data set identifier corresponding to the data set, and
the first verification is based on one or more responses to requests for specific sections of the plurality of sections.

9. The system of claim 8, wherein
at least one of the data set identifier and the section identifier of each section is embedded in the section as at least one watermark.

10. The system of claim 9, wherein
the at least one watermark includes:
a fragile watermark that is configured such that a modification of the section causes damage to the fragile watermark, and
a robust watermark that is configured such that a removal of the robust watermark causes damage to the associated section.

11. The system of claim 10, wherein
the data items correspond to at least one of: digitally encoded audio content, and digitally encoded video content.

12. The system of claim 1, wherein
each data item of the plurality data items includes one or more sections, thereby forming a plurality of sections comprising the data set,
each section of the plurality of sections including a section identifier corresponding to the section and a data set identifier corresponding to the data set, and
the second verification is based on a number of different sections received, compared to a total number of sections comprising the data set.

13. The system of claim 12, wherein
at least one of the data set identifier and the section identifier of each section is embedded in the section as at least one watermark.

14. The system of claim 1, wherein
each data item of the plurality data items includes one or more sections, thereby forming a plurality of sections comprising the data set,
each section of the plurality of sections including a section identifier corresponding to the section and a data set identifier corresponding to the data set, and
the second verification is based on a verification of at least one of the section identifier and the data set identifier of randomly selected sections.

15. The system of claim 14, wherein
the at least one of the data set identifier and section identifier is embedded in the randomly selected sections as at least one watermark.

16. The system of claim 15, wherein
the at least one watermark includes:
a fragile watermark that is configured such that a modification of the section causes damage to the fragile watermark, and
a robust watermark that is configured such that a removal of the robust watermark causes damage to the associated section.

17. The system of claim 1, wherein
the verifier is further configured to provide the verification of the presence of the data set via a third verification of a correspondence among identifiers of the data set in each of the received data items.

18. A method of controlling a rendering of data items of a data set, comprising:
receiving sections of the data set,
conducting a first test for a presence of an entirety of the data set based on a receipt of randomly selected sections of the data set,
conducting a second test for the presence of the entirety of the data set based on a receipt of a quantity of different sections of the data set, and
controlling the rendering of the data items in dependence upon a result of either the first or second test.

19. The method of claim 18, further including
conducting a third test for the presence of the entirety of the data set based on a correspondence among a data set identifier that is included in each section of the data set.

20. The method of claim 18, wherein
each section further includes a section identifier, and
at least one of the section identifier and the data set identifier is included in each section as one or more watermarks.

21. The method of claim 20, wherein
the one or more watermarks include:
a robust watermark that is embedded in the corresponding section such that a removal of the robust watermark causes a corruption of data contained in the section, and
a fragile watermark that is embedded in the corresponding section such that a modification of the data contained in the section causes a corruption of the fragile watermark.

22. The method of claim 18, wherein the data items includes at least one of: digitally encoded audio content, and digitally encoded video content.

23. The method of claim 18, wherein
conducting the second test includes verifying a random selection of the different sections of the data set.
